(19) United States
(12) Patent Application Publication
(10) Pub. No.: US 2010/0295264 A1
(43) Pub. Date: Nov. 25, 2010

(54) Airless, Chainless Bicycle

(76) Inventor: Vince Denais, Corpus Christi, TX (US)

Correspondence Address: GUNN, LEE & CAVE, P.C., 300 CONVENT ST., SUITE 1080, SAN ANTONIO, TX, 78205, US

(21) Appl. No.: 12/468,642

(22) Filed: May 19, 2009

(51) Int. Cl. B62M 1/06; B60C 7/00; B62J 1/00; B62K 3/02; B60W 10/18

(52) U.S. Cl. 280/260; 152/312; 297/215.13; 280/288; 192/217.1

(57) ABSTRACT

A durable, airless, chainless bicycle multiple riders of differing heights is disclosed. The bicycle is propelled by a drive shaft instead of a chain, making the drive assembly more dependable. The tires are made from a solid material and cannot go flat. The frame and other components of the bicycle are either inherently rust resistant or are coated to increase their rust resistance. The bicycle also has a front basket that is mounted such that the basket does not turn when the front wheel turns. Finally, the bicycle has a seat adjustment mechanism which allows the seat height to be adjusted without tools.

### BACKGROUND OF THE INVENTION

1. Field of the Invention

The present invention generally relates to bicycles. More specifically, the invention relates to a bicycle that has a combination of features making it low maintenance and that is resistant to the wear-and-tear caused by harsh environments and frequent use. The present invention discloses a bicycle that is propelled by a drive shaft, has solid, airless tires, and rust resistant metal components.

2. Background Information

Bicycles have been used as a mode of transportation and recreation for centuries. Bicycles have a variety of purposes—from racing down the streets of France and mountain biking up the Rocky Mountains to making deliveries in the city. As bicycle technology advanced and bicycles evolved, different types of bicycles emerged which are tailored to the specific activities for which the bicycle is used. Today there are road bikes, mountain bikes, triathlon bikes, racing bikes, dirt bikes, tandem bikes, and cruiser bikes, just to name a few. If there is a bicycling activity, chances are there is a special bicycle adapted for that activity.

Despite the variety of specialty bicycles available, there are no specialty bikes that are reliable in harsh working environments, tailored for use by multiple riders, and require little to no maintenance. Such a bicycle would be desirable in the bicycle rental industry, for example, where the rental bikes are extensively used by different riders, but, the bikes need to be reliable and relatively maintenance free. Another example of where such a bicycle is needed is at oil refineries or other industrial plants which have numerous buildings located across several acres of land. While one could possibly walk from location to location on the refinery grounds, riding a bicycle can be more efficient—especially when there is considerable distance between point “A” and point “B.”

In fact, workers at refineries and other plants already use bicycles as a mode of transportation on the plant grounds. Typically, these so-called “work bikes” are bicycles that were once used as racing bikes, mountain bikes, leisurely beach cruisers, or some other type of specialty bicycle. With years of wear-and-tear, work bikes are usually old, rusted, chain driven bicycles with traditional air-inflated tires. The work bikes are ridden from location to location on the plant grounds and then left outside for the next user. More often than not, the work bikes stay outside twenty-four hours a day, seven days a week, typically in extreme environments.

Concerning the environment, refineries are usually located along the southern coastline of the United States, where hot temperatures, high humidity, and salt water from the ocean all contribute to accelerated deterioration of the work bikes. This type of environment causes the work bikes wear out quickly and ultimately leads to failure of the bicycle parts and possibly, injury accidents. For example, the chains often rust quickly causing them to “kink” or break during use. Rust also affects the frame of the bicycle—especially where the paint is chipped—and the frame may become too brittle to support a rider. Furthermore, the component parts of the bicycle, such as the hand brakes or sprockets, also rust in the extreme environments. With hand brakes, the rust often causes the brakes to stick or the cables to snap.

Traditional chain-driven bicycles are not well-suited to be work bikes. Typically, the chains and/or the sprockets are the first components to rust, as compared to other components on the bicycle. To avoid rusting, the chain drive system requires regular maintenance and lubrication. In addition to worn parts and regular maintenance, loose pant legs get caught in the chain of traditional bicycles, which also can cause accidents. The fact is, the chain is commonly considered the primary cause of accident and injury for work bikes in the industrial environment.

To avoid the problems associated within chain-driven bicycles, chainless bicycles exist in the prior art. Dynamic Bicycles, Inc. discloses several bicycles with a “shaft drive” instead of a traditional chain. Using several gears, the shaft drive bicycle transfers a rider's work at the pedals through a drive shaft to a hub on the rear wheel. The Dynamic shaft drive bicycles operate in conjunction with hubs designed by Shimano, Inc. The hubs come from Shimano's series of “Nexus Internally Geared Hubs” and each of these hubs contains multiple gears, allowing each Dynamic bicycle to be a multiple-geared, shaft-driven bicycle.

Despite the advantages of the shaft drive, the Dynamic bicycles are still not well-suited to be a work bike. For one thing, the Dynamic bikes have traditional, air-inflated tires, which struggle in extreme environments. Further, the Dynamic bikes have other external components that are not durable against these harsh environments. For example, the hand-operated braking system has cables and other parts that will not resist rust effectively.

Neither the Dynamic bicycles nor other bicycles that exist in the art disclose a durable, must resistant, chainless bicycle with airless tires. In addition, neither the Dynamic bicycles nor other bicycles in the art disclose a durable, chainless bicycle having a coaster brake—a brake which is more resistant to the effects of extreme environments. Moreover, neither the Dynamic bicycles nor other bicycles in the art disclose a durable, chainless bicycle having a seat that is adjustable without the necessity of tools. Finally, neither the Dynamic bicycles nor other bicycles that exist in the art disclose a durable, chainless bicycle having a basket mounted over the front wheel which does not turn when the front wheel turns.

### SUMMARY OF THE INVENTION

The objective of the present invention is to provide a novel chainless bicycle that is well-suited for use in harsh environments. In line with this objective, the bicycle of the present invention has a drive assembly that contains a drive shaft and has airless tires which cannot go flat. Additionally, the bicycle of the present invention has a coaster brake, which eliminates the need for wires and other easily degradable components associated with hand brakes. Furthermore, the bicycle has a frame and metal components that are coated, making them rust resistant.

It is a further objective of the present invention to provide an airless, chainless bicycle that is easily operable by several different users. In line with this objective, the chainless bicycle of the present invention has a seat adjustment assembly that allows the seat height to be adjusted without the necessity of tools.

It is yet another objective of the present invention to provide a bicycle that has the ability to carry safely small loads and the present invention preferably has a front basket extending over the front wheel to meet this objective. The front basket is attached to the bicycle frame so that the handle bar assembly and front wheel of the bicycle can turn without also turning the basket.

### BRIEF DESCRIPTION OF THE DRAWINGS

FIG. 1 is a side elevation view of the preferred embodiment of the present invention.

FIG. 2 is a perspective view of the preferred embodiment of the present invention.

FIG. 3 is a perspective view of the front wheel of the present invention.

FIG. 4 s a cross sectional view along lines 4-4 in FIG. 1 which shows the front airless tire and the front rim.

FIG. 5 is a cross section perspective of FIG. 4 with the airless tire exploded from the rim.

FIG. 6 is a sectioned perspective view of the rear wheel assembly and shaft drive of the present invention.

FIG. 7 is perspective view of a portion of the drive assembly and a portion of the pedal assembly of the present invention.

FIG. 8 is a perspective view of the internal structure for the drive assembly and the pedal assembly of the present invention.

FIG. 9 is a perspective view of the rear hub and internal components of the shaft drive assembly connecting to the rear hub.

FIG. 10 a sectioned perspective shows the rear wheel from a top, rear view and illustrates the interaction of the drive assembly with the rear wheel.

FIG. 11 is a perspective view of the seat and seat adjustment assembly of the present invention.

FIG. 12 is an exploded perspective view of the preferred seat adjustment assembly of the present invention.

FIG. 12A is a cross sectional side view of the seat adjustment assembly along line 12A-12A in FIG. 11.

FIG. 13 is an exploded perspective view of the preferred front basket with its attachment assembly.

### DETAILED DESCRIPTION OF THE PREFERRED EMBODIMENT

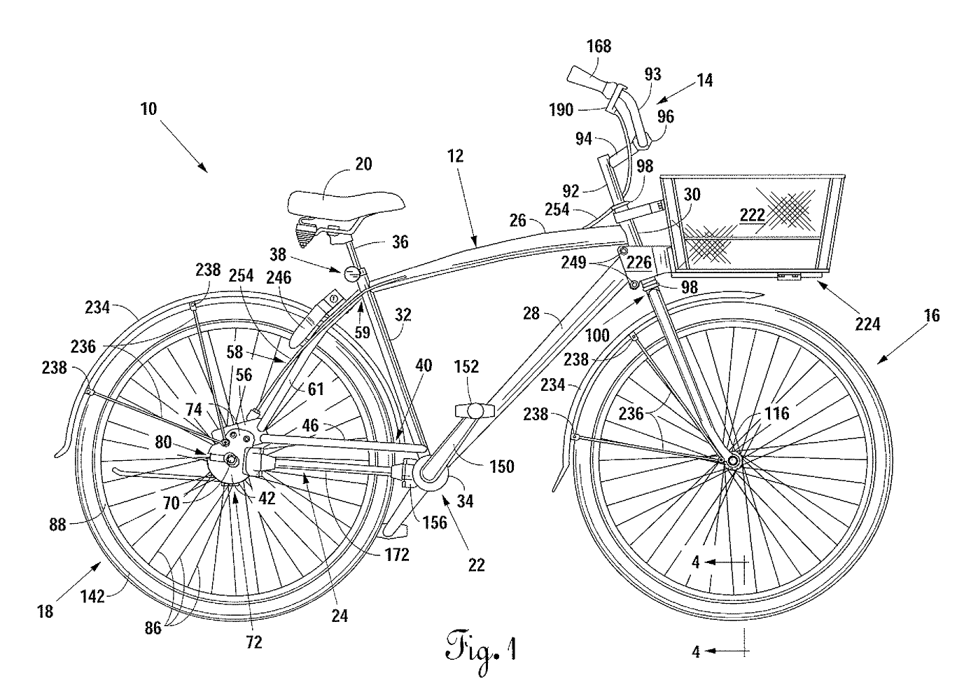

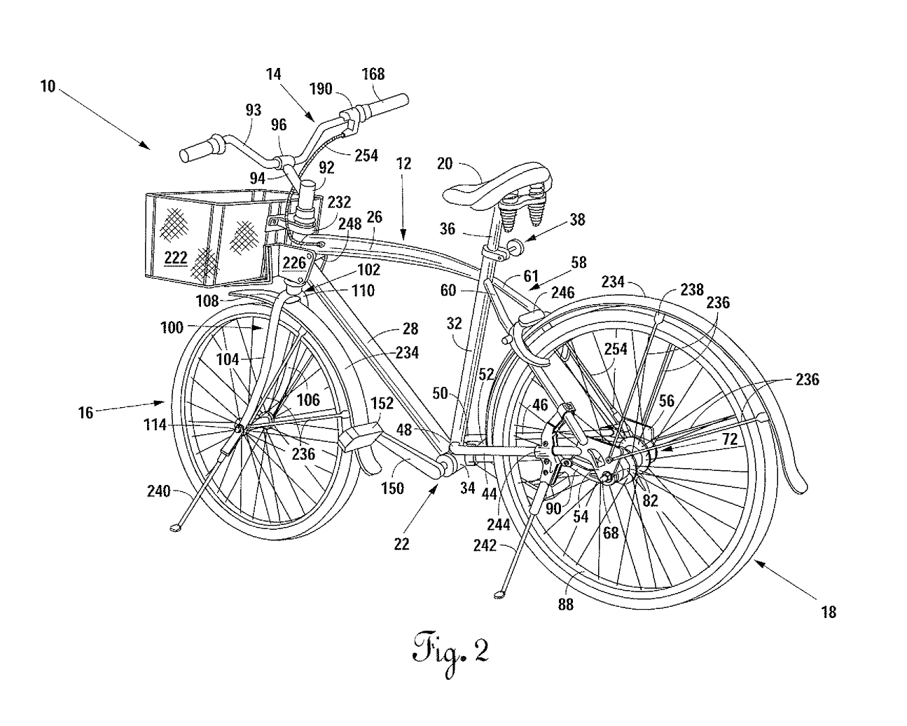

The preferred embodiment of a bicycle 10 of present invention is illustrated in FIGS. 1 and 2. In its most basic elements, the bicycle 10 has a frame 12 with a handle bar assembly 14, a front wheel 16, a rear wheel 18, a seat 20, a pedal assembly 22, and a drive assembly 24, which are all somehow directly or indirectly attached to the to the frame 12, as described in further detail herein.

The frame 12 has an upper frame member 26, a lower frame member 28, a front frame member 30, a rear frame member 32, and a bottom bracket 34. Beginning at the front frame member 30, the upper frame member 26 connects to and extends from the front frame member 30 toward the rear of the bicycle 10 and terminates where it is connected to the rear frame member 32. The lower frame member 28 is positioned below the upper frame member 26, and, is connected to and extends from the front frame member 30 at a downward angle toward the pedal assembly 22. The lower frame member 28 terminates at and is connected to the hollow bottom bracket 34, which is preferably cylindrical.

The rear frame member 32, which also has one end connected to the bottom bracket 34, extends from the bottom bracket 34, past the connection point where the upper frame member 26 and the rear frame member 32 connect, and toward the seat 20, which is mounted on a seat rod 36. The rear frame member 32 is at least partially hollow and the seat rod 36 is inserted into and slideable within the hollow portion of the rear frame member 32. As discussed infra, the amount of insertion of the seat rod 36 into the rear frame member 32 is controlled by a seat adjustment assembly 38.

It should be noted that the upper frame member 26, the lower frame member 28, the front frame member 30, and the rear frame member 32 can be any form of elongated rigid body. Although preferably shaped in various cylindrical forms, the frame members alternatively could have a rectangular or some other polygonal cross sectional area. Further, although preferably hollow, some embodiments of the upper and lower frame members 26, 28 may be completely solid or partially solid. Preferably, each of the frame members are connected with welds, however, other means of connecting are anticipated.

Connected to the rear frame member 32 is a lower rear forked member 40. Though preferably welded to the rear frame member 32 of the frame 12, those in the art will appreciate that the lower rear forked member 40 could be connected to the frame 12 with fasteners or other means. The lower rear forked member 40 has a first arm 44 and a second arm 46 that each extend in a generally horizontal direction from the rear frame member 32 (see FIG. 2). The first and second arms 44, 46 are typically aligned substantially parallel—and in some cases totally parallel—to the ground. However, it is anticipated that in some embodiments the first and second arms 44, 46 could also be slightly angled with respect to the ground or each other.

The first and second arms 44, 46 are preferably welded to the rear frame member 32. Alternatively, the first and second arms 44, 46 could be connected to a single extending member (not shown) which is securely connected to and extending from the rear frame member 32. In this embodiment, the first and second arms 44, 46 are not attached directly to the rear frame member 32.

In the preferred embodiment, the first and second arms 44, 46 originate from approximately the same height on the rear frame member 32 and then curve away from each other through a bend 48 in the first arm 44 and a bend 50 in the second arm 46 (see FIG. 2). Coming from the bends 48, 50, the first and second arms 44, 46 slightly angle away from each other as the arms extend further from the rear frame member 32. The angle at which the first and second arms 44, 46 extend from the bends 48, 50 is typically slight and may not be present at all. Such would be the case in embodiments where the bends 48, 50 each create an effective angle of 90° and the first and second arms 44, 46 stay aligned parallel to each as they extend away from the bends 48, 50.

A cross member 52 is preferably positioned between the first and second arms 44, 46 for increased stability. When present, one end of the cross member 52 is attached the first arm 44 and the other end is attached to the second arm 46 (see FIG. 2). The respective ends of the cross member 52 are attached to the first and second arms 44, 46 adjacent the position at which the arms come out of the bends 48, 50, as they extend away from the rear frame member 32.

At their distal end with respect to the rear frame member 32, the first and second arms 44, 46 terminate at and connect with a first connection plate 54 (see FIG. 2) and a second connection plate 56 (see FIG. 1), respectively. Preferably, the pieces are separately manufactured, with the first arm 44 welded to the first connection plate 54 and the second arm 46 welded to the second connection plate 56; however, the arms and their respective connection plates could be attached in some other manlier, or, they could be formed from the same integral piece of material.

The first and second connection plates 54, 56 are aligned substantially parallel, if not completely parallel, to each other. In the preferred embodiment of the present invention, the first and second connection plates 54, 56 angle inward at their connection with the first and second arms 44, 46, with “inward,” “inner,” and “interior,” as used herein, referring to a direction toward or oriented nearer to an imaginary plane extending through the centerline of the bicycle 10 from front to rear. It will be appreciated, however, that when the slight angling of the first and second arms 44, 46 away from each other is not present, the first and second connection plates 54, 56 would not have to angle toward each other to achieve substantially parallel alignment.

Also present in the preferred embodiment is an upper rear forked member 58 connected to and extending from the rear frame member 32. The upper rear forked member 58 a first arm 60 and a second arm 61 connected to and extending from the rear frame member 32. Like the lower rear forked member 40, the first and second arms 60, 61 are preferably welded to the rear frame member 32. Alternatively, the first and second arms 60, 61 could be connected to an extending member (not shown) which is in turn connected to and extending from the rear frame member 32. Furthermore, the upper rear forked member 58 could also be connected using fasteners or through some other method.

Preferably, the first and second arms 60, 61 of the upper rear forked member 58 connects to the rear frame member 32 opposite the position where the upper frame member 26 connects to the rear frame member 32; however, it is anticipated that the upper rear forked member 58 could extend from the rear frame member 32 anywhere above the point where the lower rear forked member 40 connects to the rear frame member 32.

In the preferred embodiment, the first and second arms 60, 61 extend from the body 59 at a downward angle toward the first and second connection plates 54, 56, respectively. The first and second arms 60, 61 go through an initial outward bend and then slightly angle away from each other (see FIG. 2), similar to the manner in which the first and second arms 44, 46 of the lower rear forked member 40 extend from the rear frame member 32. It should be noted, however, that the degree of each initial bend in the first and second arms 60, 61 of the upper rear forked member 58 may not be as great as the bends 48, 50 in the first and second anus 44, 46 of the lower forked element 40. Furthermore, the first and second arms 60, 61 also preferably extend through a second bend in the downward direction after they extend through their initial outward bend.

The first and second arms 60, 61 preferably terminate at connections with the first and second connection plates 54, 56, respectively. Alternatively, the first and second arms 60, 61 of the upper rear forked member 58 could connect with and terminate at the first and second alms 44, 46 of the lower rear forked member 40.

Like the preferred embodiment of the lower rear forked member 40, a cross member (not shown) is also preferably positioned between the first and second arms 60, 61 for stability purposes, with one end of the cross member being attached the first arm 60 and the other end being attached to the second aim 61. The respective ends of the cross member are attached to the first and second arms 60, 61 just after the arms extend out of their initial outward bends.

Turning now to FIGS. 1, 2, and 6 through 10, the bicycle 10 is propelled by the pedal assembly 22 and the drive assembly 24. The pedal assembly 22 has an axle housing 144 that is partially contained within the bottom bracket 34 of the frame 12. Because the preferred embodiment of the bottom bracket 34 is cylindrical, the preferred embodiment of the axle housing 144 is also cylindrical. However, both the bottom bracket 34 and the axle housing 144 could be shaped differently. Unlike the preferred bottom bracket 34, the diameter of the preferred axle housing 144 varies for the different parts of axle housing 144. In this regard, the preferred axle housing 144 is essentially four adjacent cylinders of different diameters, though more or less cylinders could be present.

The axle housing 144 has one cylinder that is an inner housing portion 144a with a diameter that is smaller than the diameter of the bottom bracket 34, allowing that portion of the axle housing 144 to fit within the bottom bracket 34. Preferably, the inner housing portion 144a has cutouts 146 on is outer wall, which are areas where the outer radius of the inner housing portion 144a temporarily decreases in length. The resulting cutouts 146 around the outer circumference of the inner housing 144a create a space between the inside wall of the bottom bracket 34 and the outside wall of the axle housing 144 at the cutouts 146.

The axle housing 144 also an outer housing portion 144b, which is a cylinder on each end of the inner housing portion 144a. The outer housing portion 144b has an outer diameter that is at least as large as the diameter of the bottom bracket 34 and thus, the outer housing portion 144b cannot fit within the bottom bracket 34. Furthermore, the outer housing portion 144b is immediately adjacent the inner housing portion 144a, which prevents the inner housing portion 144a from moving transversely within the bottom bracket 34, thereby securing the inner housing portion within the bottom bracket 34.

A pedal gear housing 144c is adjacent to one of the outer housing portions 144b and is the fourth cylinder on the preferred axle housing 144. As will be seen, the pedal gear housing 144c contains a pedal gear 154 that rotates therein. Although it preferably has an outer diameter larger than the outer diameter of the outer housing portion 144b, the pedal gear housing could have a diameter that is equal to, or even smaller than, the outer diameter of the outer housing portion 144b.

A pedal axle 148 is contained partially within the axle housing 144 but has both ends positioned outside the axle housing 144. The pedal axle 148 is aligned generally transverse to the lower frame member 28 and typically extends through the center of the axle housing 144. The pedal axle 148 attaches to a pedal arm 150 at each of its outside ends in a manner that is well known in the art. Relative to the pedal axle 148, the distal end of each pedal arm 150 has a pedal 152 attached thereto, again, in a manner that is well known in the art.

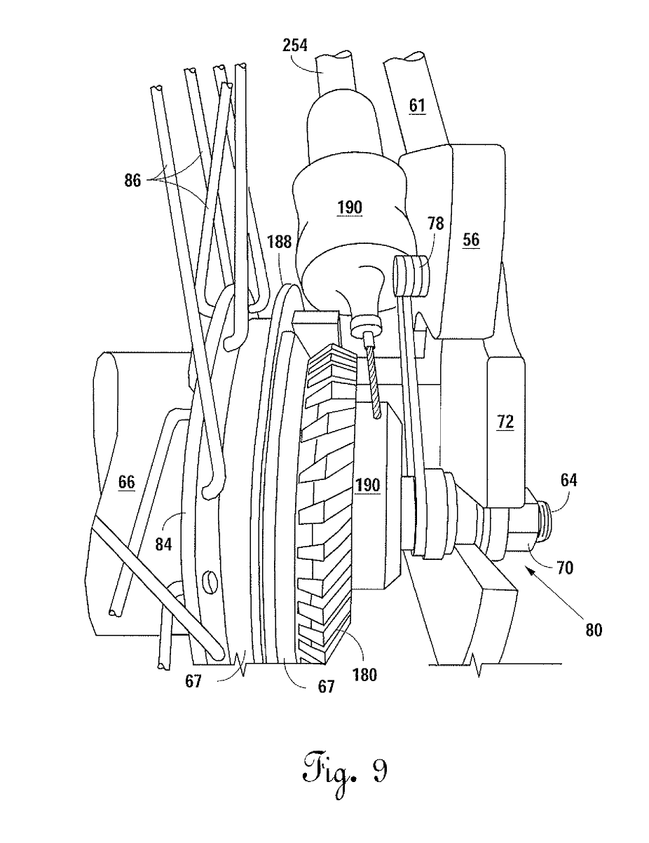

The pedal gear 154 is fixed to the pedal axle 148 within pedal gear housing 144c such that when the pedal axle 148 rotates the pedal gear 154 also rotates (see FIG. 8). The gear teeth of the pedal gear 154 face inward, away from the nearest pedal arm 150.

A front shaft-gear housing 156, which is positioned at the rear of the axle housing 144, is essentially a hollow cylinder with fastener tabs 158 positioned around its circumference. The front shaft-gear housing 156 is positioned such that it encases a rear portion of the pedal gear 154 and a front shaft-gear 164.

It should be noted that the preferred axle housing 144 and the preferred front shaft-gear housing 156 are preferably cast from the same mold, and as a practical matter, the two parts are actually a single piece. In this regard, the preferred front shaft-gear housing 156 also has a front shaft-gear plate 160 that is held in place with threaded fasteners 162 threaded into the fastener tabs 158. However, it is anticipated that the axle housing 144 and the front shaft-gear housing 156 could be separately manufactured and welded together, or otherwise attached, depending on the manufacturing processes available.

As part of the drive assembly 24 and as shown in FIG. 8, the front shaft-gear 164 (see FIG. 8) is fixed to the front end of a drive shaft 166. The front shaft-gear 164 is fixed to the drive shaft 166 such that when the front shaft-gear 164 rotates the drive shaft 166 also rotates. The front shaft-gear 164 teeth engage the teeth of the pedal gear 154 in geared communication so that when the pedal gear 154 rotates, the teeth of the pedal gear 154 cause the front shaft-gear 164 to also rotate, which in turn, causes the drive shaft 166 to rotate.

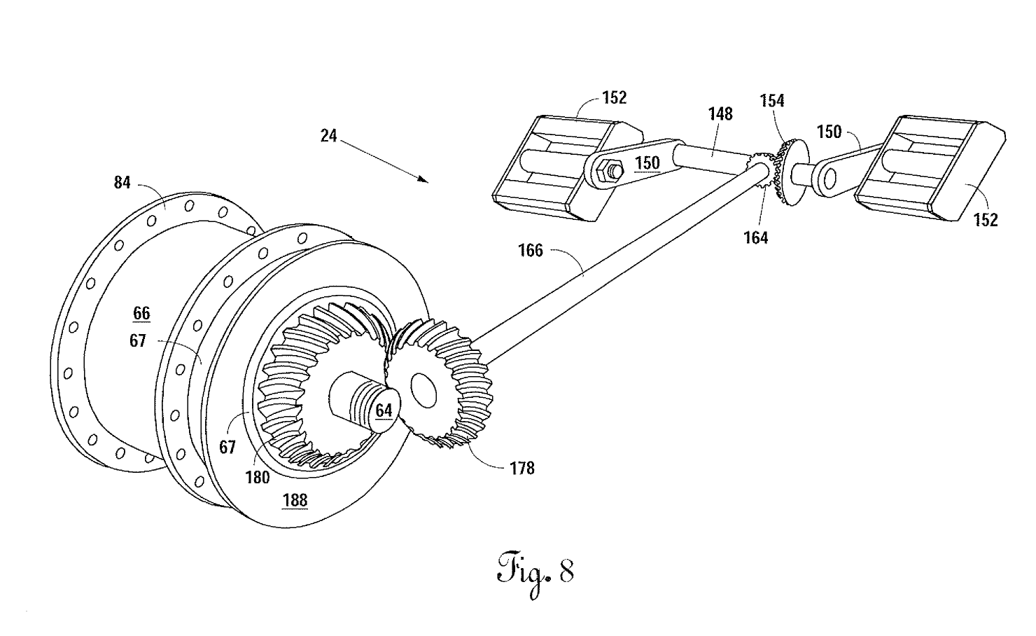

Also encased within the front shaft-gear housing 156 is a cartridge bearing (not shown) that is coupled to the drive shaft 166. The cartridge bearing, which is well known in the art, is a set of ball bearings that maintains the spatial relationship between the drive shaft 166 and the front shaft-gear housing 156. Functionally, the cartridge bearing prevents the drive shaft 166 from wobbling while allowing the drive shaft 166 to rotate. Furthermore, the front shaft-gear housing 156 also has a grease excerpt 156a mounted on its outer, bottom surface (see FIG. 7), which is used for lubricating the pedal gear 154/front shaft-gear 164 engagement.

The drive shaft 166 extends from within the front shaft-gear housing 156, toward the rear wheel 18 of the bicycle 10, to the rear gear housing 72, which encases the rear end of the drive shaft 166, a rear shaft-gear 178, at least a portion of the hub gear 180, and a cartridge bearing (not shown), which, again, maintains the spatial relationship between the drive shaft 166 and the rear gear housing 72—thereby preventing the drive shaft 166 from wobbling—yet allows the drive shaft 166 to rotate.

Preferably, the drive shaft 166 is housed within a tubular cover 172 that extends from the front shaft-gear housing 156 to the rear gear housing 72. The tubular cover 172 protects the drive shaft 166 from the external environment and prevents interference with the rotational motion of the drive shaft 166 when the bicycle 10 is in operation.

The drive shaft 166 terminates at the rear shaft-gear 178 which is fixed to the drive shaft 166 such that when the drive shaft 166 rotates the rear shaft-gear 178 also rotates (see FIG. 8). The teeth of the rear shaft-gear 178 engage with the teeth of the hub gear 180 in geared communication so that when the rear shaft-gear 178 turns the hub gear 180 also turns.

FIG. 8, which omits all the applicable housing components, shows the geared communication between various elements of the pedal assembly 22 and the drive assembly 24. As shown, when a user pushes on each pedal 152, the pedal arms 150 rotate the pedal axle 148. The rotation of the pedal axle 148 rotates the pedal gear 154, which subsequently rotates the front shaft-gear 164. When the front shaft-gear 164 rotates, the drive shaft 166 rotates and subsequently rotates the rear shaft-gear 178. The rotation of the rear shaft-gear 178 rotates the hub gear 180, which in turn, rotates the rear hub 66. The rear hub 66, which is connected to the rear wheel 18 through the rear spokes 86 (see FIG. 1), subsequently turns the rear wheel 18 and propels the bicycle 10 forward.

It should be noted that the pedal gear 154, the front shaft-gear 164, the rear shaft-gear 178, and the hub gear 180 are all preferably beveled gears, which are well known in the art. However, any type of gear, beveled or non-beveled, can be used as long as the required geared communication and subsequent rotational motion is achieved.

Also present in the preferred embodiment of the bicycle 10 is a gear shifter 190 that feeds into the internal gears of the rear hub 66 (see FIG. 9). The gear shifter 190 is operated by a cable 254 connected to one of the grips 168 on the handle bar assembly 14. Rotation of the grip 168 displaces the cable 245, which, in turn, activates the gear shifter 190 and shifts internal gears within the rear hub 66 in a manner that is well known in the art. Alternatively, the gear shifter 190 and the internal gears could be eliminated and thereby making the bicycle 10 a one gear, single speed bike.

Referring to FIGS. 1, 2, 6, 8, 9 and 10, the rear hub 66 and the hub gear 180 rotate around the static rear axle 64 in a manner that is well known in the art. In this regard, the hub gear 180 is associated with the rear hub 66 such that the hub gear 180 can cause the rear hub 66 to rotate. Preferably, the rotational association between the hub gear 180 and the rear hub 66 is accomplished through a clutch mechanism (not shown) that is well known in the art. Alternatively, the hub gear 180 could be coupled directly to the rear hub 66, which would eliminate the ability of the rear wheel 18 to “fireewheel.”

A portion of the outer surface of the rear gear rear gear housing 72 is a mounting plate 42 which has a substantially horizontal slot 80 extending from the rear edge of the mounting plate 42. One end of the rear axle 64 is inserted through the slot 80. A tabbed portion 74 at the top side of the mounting plate 42 has mounting holes 75 (see FIG. 7) which correspond to mounting holes (not shown) on the second connection plate 56. Fasteners 78 (see FIGS. 9 & 10) passing through the mounting holes 75 and the receiving holes connect the second connection plate 56 to the rear gear housing 72. Alternatively, the second connection plate 56 and the mounting plate 42 could be formed from the same integral piece of material, thereby eliminating the need for the fasteners 78 and the mounting holes 75.

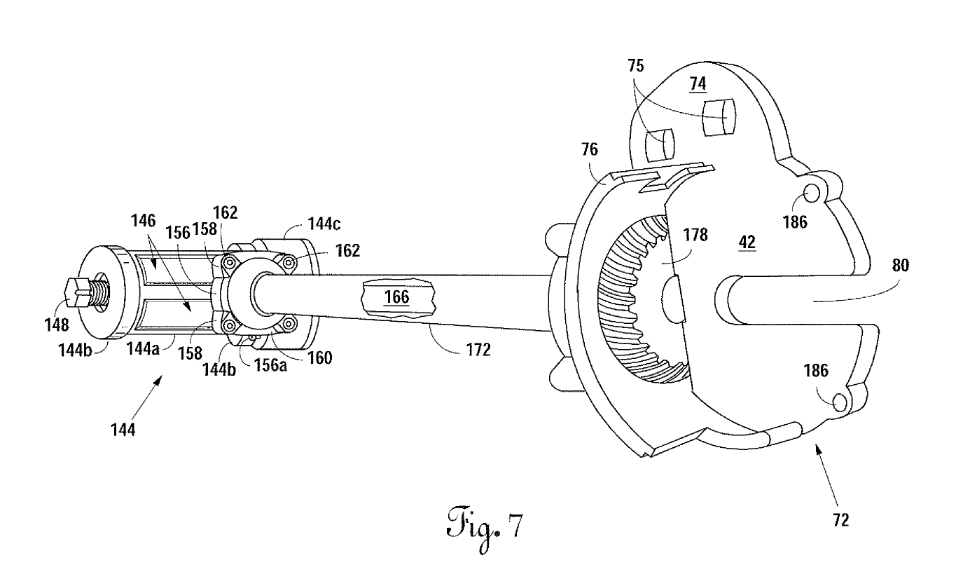

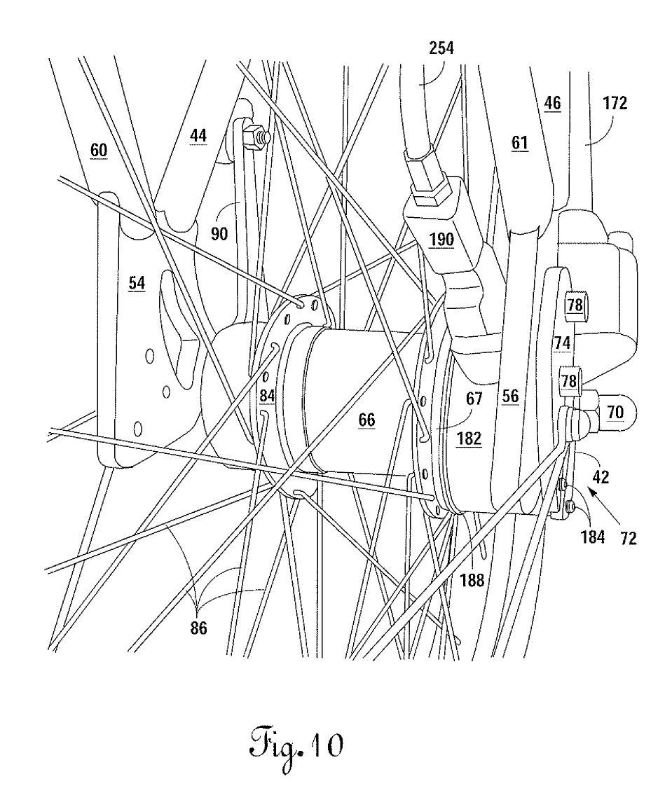

The rear gear housing 72 has a curved surface 76 on its interior side (see FIG. 7) that joins with a dust cover 182 (see FIG. 10) to form a substantially cylindrical surface on the interior side of the rear gear housing 72, which partially protects the hub gear 180 from dust and other particles. The dust cover 182 is preferably mounted to the interior side of the rear gear housing 72 with fasteners 184 extending through dust cover mounting holes 186 (see FIG. 7). A flanged element 59 (see FIG. 6) extends horizontally from the outer edge of the dust cover 182 slides into the slot 80 of the rear gear housing 72 and covers the portion of the slot 80 that is not occupied by the rear axle 64, when the dust cover is mounted to the rear gear housing 72.

A dust plate 188 is positioned around the rear axle 64, between the rear hub 66 and the interior surface of the rear gear housing 72 (see FIG. 10). Preferably, the dust plate 188 is circular and is substantially adjacent to the interior surface of the rear gear housing 72. In this regard, FIG. 9 shows the dust plate 188 adjacent to interior surface of the rear gear housing 72 as seen through a space that is normally occupied by the dust cover 182, which is removed for purposes of illustration. The dust plate 188 combines with the rear gear housing 72 and the dust cover 182 to completely encase the hub gear 180, thereby protecting the hub gear 180 and the hub gear 180/rear shaft-gear 178 engagement from dust and other particles.

The dust plate 188 is mounted on a hub cap 67 which caps the end of the rear hub 66 nearest the hub gear 180, and, the hub cap 67 and the dust plate 188 are mounted such that they rotate when the hub gear 180 rotates. In this regard, the hub gear 180, the dust plate 188, and the hub cap 67 are preferably mounted to the same part of the clutch mechanism (not shown); however, the combination of the dust plate 188 and the hub cap 67 could also be a part of the hub gear 180 or could be connected to the hub gear 180. In the preferred embodiment, the hub cap 67 is and abuts the inner side of the hub gear 180 (see FIG. 9). On its opposite side, the hub cap 67 covers the outer edge of the rear hub 66. The rear hub 66 is rotatable within the hub cap 67 such that when the rear wheel 18 is freewheeling—because the clutch mechanism (not shown) is not engaged with the hub gear 180—the rear hub 66 rotates but the hub cap 67 and dust plate 188 do not. The hub cap 67 helps prevent dust and other particles from entering into the internal components of the rear hub 66, such as the internal gears) portions of the clutch mechanism, and portions of the coaster brake (not shown) discussed below.

As noted, the rear axle 64 has one end extending through the slot 80 of the rear gear housing 72 when the rear wheel 18 is mounted to the bicycle 10. The other end of the rear axle 64 extends through a slot 82 on the first connection plate 54. The slots 80, 82 typically open rearwardly away from the frame 12 so that the rear axle 64 slides toward the frame 12 when inserted, but, other embodiments of the slots 80, 82 could open in another direction. Once the rear wheel 18 is mounted a first nut 68 and a second nut 70 are placed on opposite ends of the rear axle 64 and are threaded onto the rear axle 64 until the rear axle 64 is secured, thereby securing the rear wheel 18 to the bicycle 10

The rear axle 64 (see FIG. 8) passes through the center of the rear hub 66. The rear hub 66, which indirectly receives energy from the drive assembly 24 through the hub gear 180, helps propel the bicycle 10 forward. The rear hub 66 has a flange 84 at each of its ends and each flange 84 has rear spokes 86 attached to it. As is well known in the art, the rear spokes 86 extend radially outward from each flange 84, and, the rear spokes 86 intersect with and connect to the inner circumference of a rear rim 88.

Although not shown in detail, a coaster brake is present in the preferred embodiment of the bicycle 10 and the rear wheel attachment assembly 62. Coaster brakes and their operation are well known in the art. They typically utilize brake shoes (not shown) contained within the rear hub 66 to stop the bicycle 10. When a user pedals backward, a clutch mechanism (not shown) pushes the brake shoes radially outward and the brake shoes press against the inner surface of the rear hub 66. The brake shoes are statically fixed on the none rotating rear axle 64 when they are engaged with the rear hub 66 and frictional forces cause the rotating rear hub 66 to stop rotating

When the clutch mechanism (not shown) presses the brake pads against the inner surface of the rotating rear hub 66, the rotational force of the rear wheel 18 transfers to the rear axle 64 because the rear axle 64 is effectively holding the engaged brake pads (not shown) static. Without a resisting force, the transferred rotational force is too great for the first and second nuts 68, 70 withstand and the normally static rear axle 64 begins to rotate, which loosens the first and second nuts 68, 70. To resist the transferred rotational force of the rear wheel 18, a coaster brake arm 90 is present. The coaster brake arm 90 has one end coupled to the rear axle 64 in such a way that the rear axle 64 cannot freely rotate within that end. The other end of the coaster brake arm 90 is mounted to the first arm 44 of the lower rear forked member 40. When the rear axle 64 tries to rotate within its end of the coaster brake arm 90, the coaster brake arm 90 transfers the force to it to the other end, where it is absorbed by the lower rear forked member 40.

Turning now to the front end of the bicycle 10 and referring to FIGS. 1 and 2, a steering rod 92 extends between the handle bar assembly 14 and a front forked member 100. Preferably, the handle bar assembly 14 has a handle bar 93 mounted to a stem 94, though it is anticipated that the handle bar 93 could be directly connected to the steering rod 92 in some embodiments. Relative to the bicycle 10, the proximal end of the stem 94 is preferably welded near the upper end of the steering rod 92, although it could be connected via some other method such as with a fastener (not shown). Alternatively, the stem 94 and the steering rod 92 may be formed from the same integral piece of material instead of being separately manufactured and connected. At its distal end, the stem 94 preferably connects to the handle bar 93 with a bracket 96, though the stem 94 also could be welded to the handle bar 93.

Although the handle bar 93 is shown as a “cruiser bicycle” handle bar, other styles of handle bars could be used, such as those typically found on a road bicycle or mountain bicycle. Further, although the frame 12 of the bicycle 10 is also depicted as a “cruiser bicycle” frame, it too could be many styles of bicycle frames available in the marketplace.

The steering rod 92 extends from the stem 94 through the hollow front frame member 30 and rotates within the front frame member 30. Preferably, the steering rod 92 passes through a headset 98 mounted on opposite ends of the front frame member 30. The headset 98 contains cartridge bearings (not shown), which are well known in the art and which allow easy rotation of the steering rod 92 within the front frame member 30. Preferably, the steering rod 92 and the front frame member 30 are cylindrical, but the steering rod 92 could be shaped as some type of other elongated rigid body, in which case the headset 98 and its cartridge bearings would have to be adapted accordingly.

After passing through the front frame member 30, the lower end of the steering rod 92 connects with and terminates at the front forked member 100 (see FIG. 2), which has a cylindrical body 102 with a first arm 104 and a second arm 106 originating from the body 102. Preferably, the body 102 is connected to the steering rod 92 with a bolt and nut-type fastener (not shown) and the first and second arms 104, 106 are welded to the body 102.

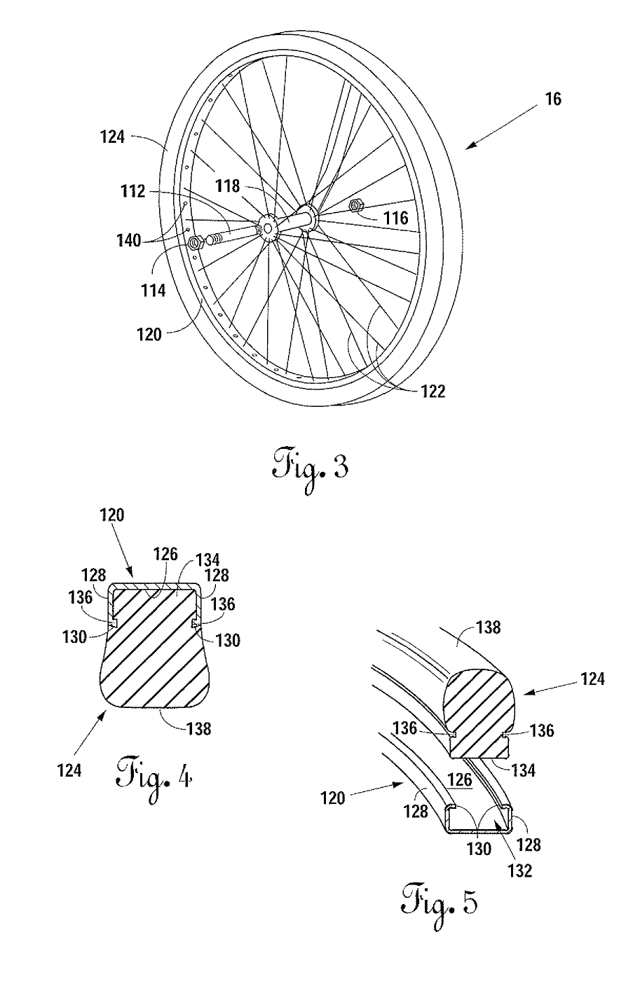

In the preferred embodiment, the first and second arms 104, 106 extend from the body 102 of the front forked member 100 through a first bend 108 and a second bend 110, respectively. By extending through their respective bends, the first and second arms 104, 106 become aligned substantially parallel, if not totally parallel, to each other. Preferably, the first and second arms 104, 106 are generally cylindrically shaped but have a reducing diameter as they extend toward their distal end. At their distal end, the first and second arms 104, 106 each have a slot (not shown) with openings facing downward to receive a front axle 112 therein (see FIG. 3). By sliding the front axle 112 upward into the slots, the front axle 112 has one end positioned in the slot on the first arm 104 and the other end positioned in the slot on the second arm 106. Alternatively, the slots in the first and second arms 104, 106 could have their openings facing another direction.

In alternative embodiments of the front forked member 100, the first and second bends 108, 110 may each be true right angles, with the body 102 being directly perpendicular to the first and second arms 104, 106. Typically, such will be the case if the front forked member 100 has a front suspension system (not shown). Front suspension systems, which are well known in the art, can be built into the first and second arms 104, 106 in the form of a shock (not shown) on each arm, or, may in the form of a shock (not shown) located between the body 102 of the front forked member 100 and the lower end of the steering rod 92.

The front axle 112 is secured to the first and second arms 104, 106 with a first nut 114 and a second nut 116, respectively, which thread onto opposite ends of the front axle 112 in a manner that is well known in the art.

Turning to FIG. 3, the front wheel 16 has front hub 118 in its center. The front hub 118 rotates on the static front axle 112 when the bicycle 10 is in motion. The front hub 118 is attached to a circular front rim 120 with front spokes 122 that extend radially outward from a flange on the front hub 118. The front spokes 122 terminate at and connect to the front rim 120 in a manner that is well known in the alt.

FIGS. 3, 4, and 5 depict the front rim 120 and an airless tire 124 of the front wheel 16 of the preferred embodiment. It can be appreciated that the rear rim 88 of the rear wheel 18 and a rear airless tire 142 mounted thereto are identical.

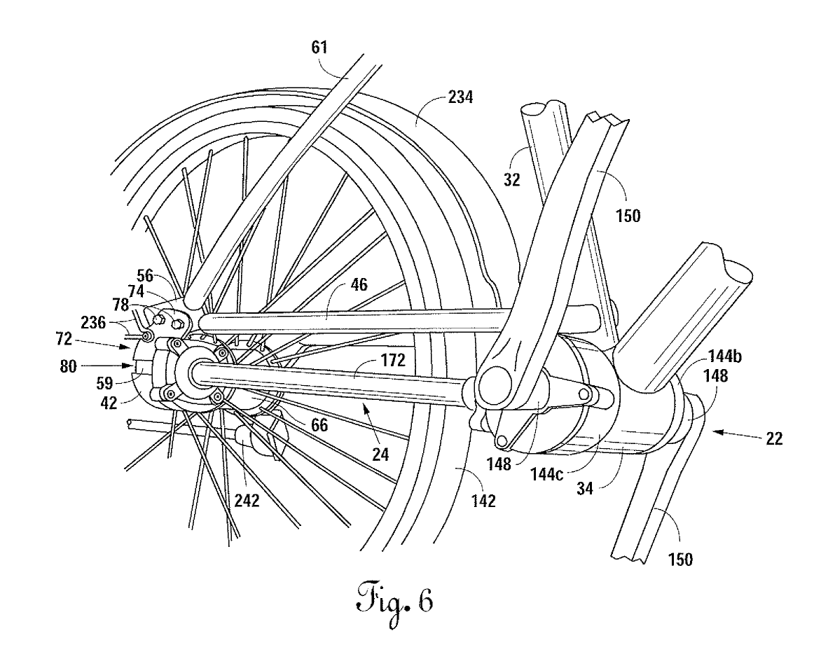

The rim 120 holds an airless tire 124 on the outer circumference of the rim 120. Referring to FIGS. 4 and 5, which show a cross section of the rim 120 and the airless tire 124, the rim 120 has a base 126 and sidewalls 128 extending radially outward from both ends of the base 126 are sidewalls 128. Preferably, the sidewalls 128 extend from the base 126 around the entire circumference of the rim 120.

Each of the sidewalls 128 has a lip 130 that protrudes inwardly from the sidewalls 128. Preferably, each lip 130 protrudes from the sidewalls 128 at a 90° angle and each of the sidewalls 128 terminates with the lip 130 at the distal end of the sidewalls 128, relative to the base 126. However, it is anticipated that the lip 130 on each of the sidewalls 128 may protrude from the sidewalls 128 at a different angle or even at differing angles as between the two lips that are present on a single rim 120. Further, it is anticipated that the lip 130 may not be located at the distal end of the sidewalls 128, but rather, each lip 130 may protrude from the sidewalls 128 closer, to the base 126.

The base 126, the sidewalls 128, and the lip 130 protruding from each of the sidewalls 128 create a cavity 132 (see FIG. 5) around the outer circumference of the rim 120. Preferably, the cavity 132 extends continuously around the entire circumference of the front rim 120, though it could be intermittent. Seated within that cavity 132 and extending around the entire circumference of the front rim 120 is an inner portion 134 of the front airless tire 124.

As shown in FIGS. 4 and 5, the airless tire 124 has an inner portion 134 and an outer portion 138 divided by mounting grooves 136 in each side of the tire. When mounted on the rim 120, the outer portion 138 of the tire makes normal contact with the riding surface and the inner portion 134 of the tire seats within the cavity 132 with each lip 130 protruding from each of the sidewalls 128 and extending into each corresponding mounting groove 136, thereby holding the inner portion 134 of the airless tire 124 in the cavity 132.

Preferably, the lip 130 on each of the sidewalls 128 and the mounting groove 136 on each side of the airless tire 124 extend around the entire circumference of the rim 120 and the airless tire 124, respectively. Although not reacquired and alternatively, fasteners 140 can be inserted through the base 126 of the rim 120 and penetrate into the inner portion 134 of the airless tire 124, thereby further securing the airless tire 124 to the rim 120. It is anticipated that the fasteners 140 could be screws, nails, staples, or other like devices

As “airless” tires, the front and rear airless tires 124, 142 are made from a solid, durable material, which in the preferred embodiment is a high density, closed cell polyurethane foam material. To be clear, “airless” means that the front and rear airless tires 124, 142 do not hold air in a continuous cavity around the tires; nor do they hold a tube with air in it. In the preferred embodiment of the bicycle 10, the front and rear airless tires 124, 142 are 26″×1.95″ all-terrain tires from Amerityre which mount to Weinniann DHL-42 rims. However, any suitable combination of sizes and types of tires and rims can be used.

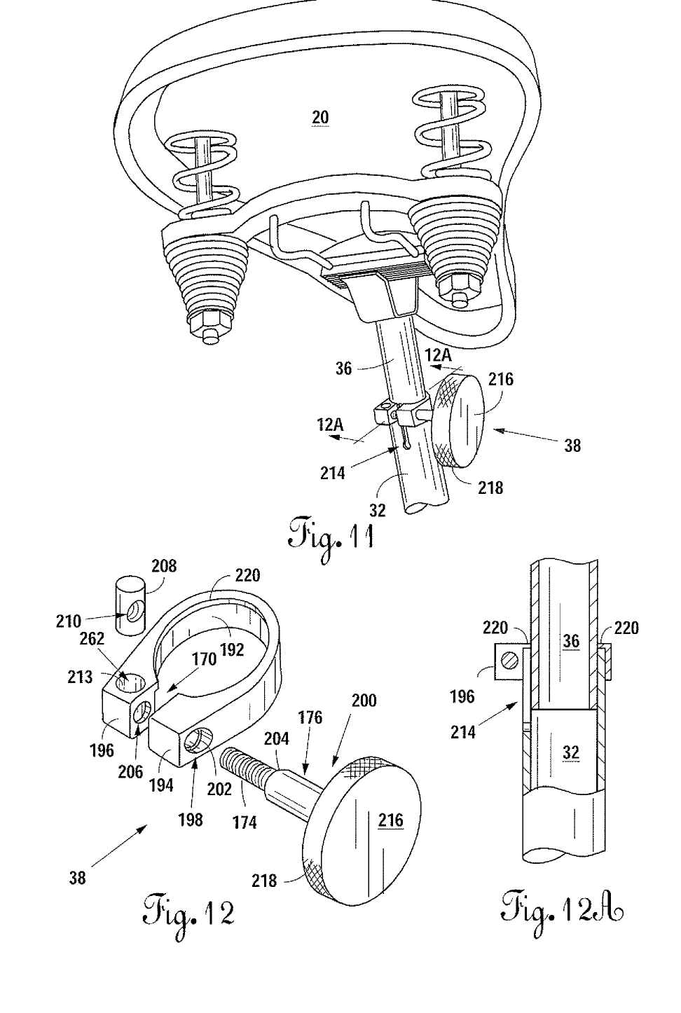

Referring now to FIGS. 11 through 12A, the preferred embodiment of the seat 20 is shown, which is a wide, extra-padded, dual-suspension seat commonly known in the art to be found on a “cruiser bicycle.” Although shown as a “cruiser” seat 20, any other style of seat could be present.

The seat 20 is mounted to the seat rod 36, which is inserted into the at least partially hollow rear frame member 32. The seat rod 36 slides freely within the hollow portion of the rear frame member 32 unless acted upon by the seat adjustment assembly 38. As will be seen, the seat adjustment assembly 38 allows quick and easy adjustment of the height of the seat 20 without the necessity of tools.

The seat adjustment assembly 38 has a clamp 192 that extends around the top perimeter of the rear frame member 32 at the junction where the rear frame member 32 receives the seat rod 36. The clamp 192 is shaped to match the outer perimeter of the rear frame member 32 but does not extend entirely around the perimeter of the rear frame member 32. Rather, the clamp 192 has a first end 194 and a second end 196 with a gap 170 between.

The first end 194 of the clamp 192 contains a first fastener-receiving passage 198, which is shaped such that the threaded portion of a shoulder bolt fastener 200 passes therethrough. The first fastener-receiving passage 198 has an internal shoulder 202 that prevents the shank 176 of the shoulder bolt fastener 200 from passing through the first fastener-receiving passage 198. In this regard, the shoulder bolt fastener 200 has a substantially flat outer shoulder 204 formed at the juncture of the shank 176 and the smaller diameter threaded portion 174 that abuts the internal shoulder 202 when the shank 176 is fully inserted in the first fastener-receiving passage 198.

The second end 196 of the clamp 192 has a second fastener-receiving passage 206 that is also configured to receive the threaded portion 174 of the shoulder bolt fastener 200. The second fastener-receiving passage 206 is axially aligned with the first fastener-receiving passage 198 such that the threaded portion 174 of the shoulder bolt fastener 200 can extend from the first fastener-receiving passage 198 into the second fastener-receiving passage 206.

The top side of the second end 196 has a first opening 213 which is adapted to received a dowel nut 208 that is shaped substantially as a cylinder and which has an internally threaded portion 210 passing diametrically the dowel nuts 208 cylindrical body. A dowel nut chamber 212 extending through the second end 186 is aligned perpendicular to and intersects the second fastener-receiving passage 206. The bottom end of the dowel nut chamber 212 terminates in an opening in the bottom of the second end 196 which has a perimeter that is slightly narrower than bottom perimeter of the dowel nut 208, thereby preventing the dowel nut 208 from passing through the dowel nut chamber 212. In alternative embodiments, the dowel nut chamber 212 may not have an opening at the bottom end.

With the dowel nut 208 being held in the dowel nut chamber 212, the internally threaded portion 210 of the dowel nut 208 is positioned and rotated to be axially aligned with the threaded portion of the shoulder bolt fastener 200. When axially aligned, the threaded portion of the shoulder bolt fastener 200 is threaded into and through the internally threaded portion 210 of the dowel nut 208, and, the outer shoulder 204 of the shoulder bolt fastener 200 abuts the internal shoulder 202 of the first fastener-receiving passage 198. Ultimately, further tightening of the shoulder bolt fastener 200 causes the gap 170 between the first end 194 and the second end 196 to narrow and thereby circumferentially compress interior surface of the rear frame member 32 into tight frictional contact with the outer surface of the seat rod 36, locking the seat rod 36 in place.

Preferably, the rear frame member 32 has a slit 214 extending longitudinally downward from its upper end (see FIG. 11), which allows greater circumferential compression force on the seat rod 36. Further, the clamp 192 preferably has a radially inward protrusion 220 that extends around the top inner surface of the clamp 192, creating a shoulder (not shown). When the clamp 192 is mounted on the rear frame member 32 the shoulder abuts the top edge of the rear frame member 32 and prevents the clamp 192 from sliding down the rear frame member 32, as shown in FIG. 12A.

The shoulder bolt fastener 200 is configured such that the seat adjustment assembly 38 can be locked and unlocked without tools. To accomplish this task, the shoulder bolt fastener 200 has an enlarged head 216 which can be easily gripped and turned by hand. In this regard, a user must be able to apply enough force at the fastener head 216 for the clamp 192 to adequately compress the rear frame member 32 and lock the seat rod 36, with adequate compression being measured by whether a user can operate the bicycle 10 without the seat rod 36 sliding tip or down within the rear frame member 32. Similarly, the next user must be able to apply enough force to loosen the threaded shoulder bolt fastener 200, which unlocks the seat adjustment assembly 38.

In its preferred embodiment, the head 216 is circular with diamond-cut knurling 218 on the outer circumferential edge. The knurling 218 facilitates gripping of the fastener head 216 and could be in a different fore. In its preferred embodiment, the head 216 is 5 cm in diameter and 1 cm in width; however, it will preferably be anywhere from 3 cm to 10 cm in diameter and anywhere from 0.5 cm to 2.5 cm in width.

As shown in FIG. 1, a basket 222 is positioned over the front wheel 16 in the preferred embodiment of the present invention. As will be seen, the basket 222 is mounted such that it does not turns when the front wheel 16 turns.

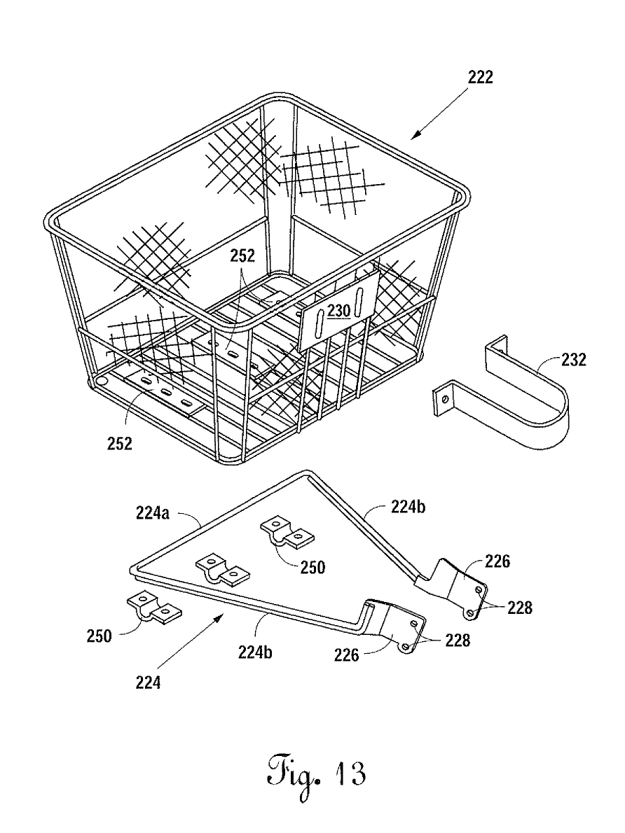

Referring to FIG. 13, the basket 222 and its mounting structure are shown in more detail. The basket 222 is mounted on a basket support structure 224 that is preferably shaped similar to a triangle with a base 224a and two sides 224b. The bottom surface of the basket 222 is preferably mounted to the basket support structure 224 with brackets 250 that extend around the base 224a of the basket support structure 224. The brackets 250 correspond to mounting plates 252 positioned on the bottom surface of the basket 222 and fasteners (not shown) extend through corresponding mounting holes on the brackets 250 and the mounting plates 252.

In alternative embodiments, the basket support structure 224 may be formed in a different shape and may be mounted to the bottom surface of the basket 222 through welds or in some other manner. Furthermore, the mounting plates 252 may be positioned differently on the bottom surface of the basket 222 and the brackets 250 may extend around one of the two sides 224b or both sides 224b.

The sides 224b of the basket support structure 224 extend from the base 224a along the bottom surface of the basket 222 at inward angles and connect to mounting brackets 226, preferably with welds. The mounting brackets 226 are positioned to mount on opposite sides of a first mounting element 248 (see FIG. 2) and a second mounting element (not shown). The mounting brackets 226 have first and second mounting holes 228 that correspond to threaded through-holes (not shown) on the first mounting element 248 and the second mounting element (not shown) on the frame 12. The threaded through-holes are aligned transverse to the frame 12. Fasteners 249 extend through the first and second mounting holes 228 of the mounting brackets 226 and into the through-holes of the first mounting element 248 and the second mounting element, thereby securing the mounting brackets 226 to the frame 12 (see FIG. 1).

The first mounting element 248 is preferably positioned adjacent the bottom surface of the upper frame member 26 and the top edge of the lower frame member 28, near the junctions of the upper frame member 26 and the rear surface of the front frame member 30 (see FIG. 2). The second mounting element (not shown) is preferably positioned adjacent the bottom surface of the lower frame member 28 and the rear surface of the front frame member 30. It is anticipated, however, that the mounting elements could be positioned elsewhere on the frame 12, as long as they are positioned are on the frame 12 at or near the front frame member 30.

On the rear side of the basket 222, a mounting plate 230 is preferably attached to the basket 222 and connected to the mounting plate 230 are the ends of a U-shaped brace 232. The “U” portion of the U-shaped brace 232 is positioned around the front frame member 30 such that the front frame member 30 extends through the inner portion of the U-shaped brace 232, with the inside portion of the “U” shape abutting the front frame member 30 (see FIG. 1).

In the preferred embodiment, the basket 222 is made from mesh with a sufficiently “tight” pattern so as to prevent small or thin objects, such as screw drivers, pencils or the like, from falling through the mesh holes. However, it is possible to have a basket 222 with larger holes in the mesh or a basket 222 with solid sides and a solid bottom, instead of mesh. In any case, the basket 222 is preferably made from stainless steel alloy, or any other suitable material that will resist rusting

The bicycle 10 also preferably has a fender 234 over the front wheel 16 and the rear wheel 18 (see FIGS. 1 & 2). The fender 234 ranges in its length, depending on the type of bicycle 10 desired. Preferably, the fender 234 is secured to the bicycle 10 by fender support rods 236 on each side of the front wheel 16 and/or the rear wheel 18. At least two fender support rods 236 are required for each fender 234 and preferably four. For the fender 234 mounted over the front wheel 16, the fender support rods 236 are connected to and extend from the distal ends of the front forked member 100. For the fender 234 mounted over the rear wheel 18, the fender support rods 236 extend from the first connection plate 54 and mounting plate 42 of the rear gear housing 72. The fender support rods 236 are attached to the fender 234 with fender support mounts 238, which are well known in the art. The fender 234 over the front wheel 16 is also preferably attached to the body 102 of the front forked member 100 with a fastener (not shown). Similarly, the fender 234 over the rear wheel 18 is also preferably attached to the cross member 52 between the first and second arms 44, 46 of the lower rear forked member 40 with a fastener (not shown) (see FIG. 2).

As shown in FIG. 2, the preferred embodiment of the bicycle 10 also has a front kickstand 240 and a rear kickstand 242. The front kickstand 240 is secured to the front axle 112 with the first nut 114, whereas the rear kickstand 242 is secured to the first arm 44 of the lower rear forked member 40, as well as the first arm 60 of the upper rear forked member 58, with a bracket 244. In should be noted however, that the front and rear kickstands 240, 242 may be mounted to the bicycle 10 in other manners that are well known in the art. Further, either the front kickstand 240 or the rear kickstand 242, or even both, may not be present.

Also present in the preferred embodiment is a lock 246 that is mounted on the cross member (not shown) that spans between the first air 60 and the second arm 61 of the upper rear forked member 58. The lock 246 is generally “C” shaped and extends around the rear wheel 18. A bar (not shown) activated by a turn key (not shown) that extends between the distal ends of the lock 246 between the rear spokes 86 and there enclosing around the rear wheel 18. The bar contacts the rear spokes 86 when the rear wheel 18 is moved and prevents someone from riding the bicycle 10.

It should finally be noted that the bicycle 10 in line with its purpose of being used in industrial applications, the bicycle 10 is preferably made from thermoplastic materials that do not rust, such as the polycarbonate fenders 234 and the plastic dust cover 182, or metallic materials that are coated to prevent rust. In the latter case, certain elements are made from stainless steel or other metallic alloys that form passivation layers which coat the element to prevent rust. In some cases, additional passivation layers are created through anodizing. For metallic components that do not form passivation layers and which cannot be anodized (e.g., carbon steel), coatings such as paint or rubberized coatings isolate these metals from the environment.

Certain components on the bicycle 10 have undergone rust preventative measures with coatings that are not oxidative passivation coatings. In the preferred embodiment, the frame 12 and the upper and lower rear forked members 40, 58 are made from 6061 aluminum alloy, which is an alloy widely used in aircraft structures. The 6061 aluminum alloy is coated, preferably with a clear-coat paint, to isolate these metallic structures from the environment. The front forked member 100 is preferably made of chromoly, a high-strength steel alloy made, in part, with chromium and molybdenum, and is also coated with a durable paint to increase their rust resistance. The basket 222 is made from a steel alloy which is durable but not rust resistant. As a result, the basket 222 is encased in a rubberized coating that protects the alloy from the environment. The front and rear kickstands 240, 242 also are painted to prevent rust.

Other components on the bicycle 10 have undergone rust preventative measures with oxidative passivation coatings. For example, the head 216 of the shoulder bolt fastener 200 is made from an anodized aluminum alloy and, therefore, has an extra layer of oxide added to its surface. The remainder of the shoulder bolt fastener 200 and most of the other hardware, if not all of the other hardware, on the bicycle 10 is stainless steel, which is coated against rust through a passivation layer of chromium oxide. For example, the fender support rods 236 and the various fasteners are stainless steel. Finally, the handle bar 93 is coated with chrome plating, making it rust resistant.

Although the present invention has been described with reference to specific embodiments, this description is not meant to be construed in a limiting sense. Various modifications of the disclosed embodiments, as well as alternative embodiments of the invention will become apparent to persons skilled in the art upon reference to the above-description of the invention. It is, therefore, contemplated that the appended claims will cover such modifications that fall within the scope of the invention.

1. A bicycle comprising:
a frame comprising a hollow front frame member, a lower frame member, an upper frame member, a rear frame member, and a bottom bracket;
said hollow front frame member being connected to said lower frame member, said lower frame member extending from said front frame member at a downward angle and terminating at said bottom bracket;
said rear frame member extending upward from said bottom bracket, said rear frame member being at least partially hollow;
said upper frame member extending from said rear frame member and connecting to said front frame member;
a pedal assembly partially contained within said bottom bracket, said pedal assembly having an axle and a pedal gear;
a shaft drive assembly having a front shaft-gear in geared communication with said pedal gear of said pedal assembly, a drive shaft extending from said front shaft-gear to a rear shaft-gear, said rear shaft-gear being in geared communication with a hub gear, said hub gear being associated with a rear hub such that said hub gear can cause rotation of said rear hub;
a rear wheel having a rim and an airless tire mounted thereto, said rear wheel being mounted around said rear hub with radial spokes extending from said rear hub to said rear rim;
a lower rear forked member connected to said rear frame member; said lower rear forked member having first and second arms, and said rear hub being mounted to said lower rear forked member between said first and second arms;
a steering assembly comprising: (1) a steering rod extending through said hollow front frame member; (2) a front forked member connected to the lower end of said steering rod, said front forked member having first and second arms; and, (3) a handle bar assembly connected to the upper end of said steering rod;
a front hub rotatably mounted to a front axle extending between said first and second arms of said front forked member;
a front wheel having a rim and an airless tire mounted thereto, said front wheel being mounted around said front hub with radial spokes extending from said front hub to said front rim;
a seat rod at least partially inserted and slideable within said hollow portion of said rear frame member, wherein the junction of said rear frame member and said seat rod occurs above the junction of said upper frame and said rear frame member; and;
wherein said frame, said rear rim, rear hub, lower rear forked member, steering assembly, front hub, front rim, radial spokes, and seat rod are metallic and are coated to prevent rust.

2. The bicycle as recited in claim 1 further comprising a seat adjustment assembly positioned at the Junction of said rear frame member and said seat rod, said seat adjustment assembly being lockable and unlockable with a threaded fastener.

3. The bicycle as recited in claim 2 wherein said rear wheel is mounted to said lower rear forked member with a rear wheel attachment assembly, said rear wheel attachment assembly comprising:
a rear axle, having said rear hub and said hub gear rotatatably mounted thereon;
a first connection plate connected to said first arm of said lower rear forked element, said first connection plate having a slot and said rear axle extending through said slot; and,
a housing at least partially encasing said rear shaft-gear and said hub gear, said housing having an outer surface with a slot for receiving said rear axle therethrough.

4. The bicycle as recited in claim 3 further comprising a second connection plate connected to both said second art of said lower rear forked member and said housing.

5. The bicycle as recited in claim 4 wherein an upper rear forked member extends from said rear frame member, said upper forked member having first and second arms, said first arm extending toward and connecting to said first connection plate and said second arm extending toward and connecting to said second connection plate.

6. The bicycle as recited in claim 5 further comprising a cross member extending between said first and second arms of said upper forked member.

7. The bicycle as recited in claim 6 further comprising a rear wheel lock mounted on said cross member.

8. The bicycle as recited in claim 7 further comprising a coaster brake mounted around said rear axle and a coaster brake arm extending from said rear axle to said first arm of said lower rear forked member and being attached thereto.

9. The bicycle as recited in claim 1 wherein said rear rim and said front rim each have first and second sidewalls with a lip extending interiorly therefrom, said lip on said first sidewall of each rim extending into a first mounting groove cut into one side of said airless tires and said lip on said second sidewall of each rime extending into a second mounting groove cut into the other side of said airless tires, when each of said airless tires is mounted onto said rear rim and said front rim.

10. The bicycle as recited in claim 9 wherein each of said first and second sidewalls are positioned around the entire circumference of said bases.

11. The bicycle as recited in claim 9 wherein each lip protruding from said sidewalls protrudes from said sidewalls at a ninety degree angle.

12. A seat adjustment assembly for adjusting the height of a bicycle seat, said seat adjustment assembly comprising:
a seat rod slideably positioned within an at least partially hollow bicycle frame member, said frame member having a longitudinal slit extending from its upper end;
a clamp member having an interior surface with a shape corresponding to the transverse cross-sectional shape of the frame member and positioned around the perimeter of said frame member, said clamp member having a first end and a second end;
a first fastener-receiving passage extending through said first end, said first fastener-receiving passage being aligned transverse to said frame member when said clamp member is mounted on said frame member, said first fastener-receiving passage having an internal shoulder around its inside perimeter;
a second fastener-receiving passage extending through said second end, said second fastener-receiving passage being axially aligned with said first fastener-receiving passage;
a dowel nut chamber in said second end, said dowel nut chamber being oriented perpendicular to and intersecting said second fastener-receiving passage;
a dowel nut insertable into said dowel nut chambers said dowel nut having an internally threaded passage extending diametrically through said dowel nut; and,
a shoulder bolt fastener having (1) a threaded portion, (2) an head, (3) a shank positioned between said head and said threaded portion, and (4) a shoulder positioned between said threaded portion and said shank,
said threaded portion being insertable through said first and second fastener-receiving passages and being threadable with said internally threaded passage in said dowel nut,
said shoulder abutting said internal shoulder of said first fastener-receiving passage when said shoulder bolt fastener is fully inserted into said first fastener-receiving passage.

13. The seat adjustment assembly of claim 12 wherein said clamp member is positioned around said frame member at said frame member's upper end.

14. The seat adjustment assembly of claim 13 wherein said clamp member has a lip extending radially inwardly from the interior surface of said clamp member, creating a shoulder.

15. The seat adjustment assembly of claim 14 wherein said (towel nut and said dowel nut chamber are substantially cylindrical.

16. The seat adjustment assembly of claim 15 wherein said dowel nut chamber extends through said second end creating a first opening in the top surface of the second end and a second opening in the bottom surface of said second end, wherein the first opening has a diameter slightly greater that the diameter of the dowel nut and the second opening has a diameter slightly less than the diameter of the dowel nut.
